(19) United States
(12) Patent Application Publication
(10) Pub. No.: US 2025/0240773 A1
(43) Pub. Date: Jul. 24, 2025

(54) TECHNIQUES FOR COMMUNICATING BASED ON REFERENCE SIGNAL ALLOCATIONS

(71) Applicant: QUALCOMM Incorporated, San Diego, CA (US)

(72) Inventors: Abdelrahman Mohamed Ahmed Mohamed IBRAHIM, San Diego, CA (US); Muhammad Sayed Khairy ABDELGHAFFAR, San Jose, CA (US); Ahmed Attia ABOTABL, San Diego, CA (US)

(21) Appl. No.: 18/416,347

(22) Filed: Jan. 18, 2024

(51) Int. Cl. H04W 72/0446; H04B 7/06; H04L 5/00; H04L 5/14

(52) U.S. Cl. CPC H04W 72/0446; H04B 7/0626; H04L 5/0051; H04L 5/14

(57) ABSTRACT

Various aspects of the present disclosure generally relate to wireless communication. In some aspects, a user equipment (UE) may receive a resource allocation for a reference signal, wherein the resource allocation for the reference signal comprises a sub-band full duplex (SBFD) symbol and a non-SBFD symbol that are within a single slot. The UE may communicate with a network node in accordance with the resource allocation. Numerous other aspects are described.

### FIELD OF THE DISCLOSURE

Aspects of the present disclosure generally relate to wireless communication and specifically relate to techniques, apparatuses, and methods for communicating based on reference signal allocations.

### DESCRIPTION OF RELATED ART

Wireless communication systems are widely deployed to provide various services that may include carrying voice, text, messaging, video, data, and/or other traffic.

The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

In some aspects, a method of wireless communication performed by a user equipment (UE) includes receiving a resource allocation for a reference signal, wherein the resource allocation for the reference signal comprises a sub-band full duplex (SBFD) symbol and a non-SBFD symbol that are within a single slot; and communicating with a network node in accordance with the resource allocation.

In some aspects, a method of wireless communication performed by a network node includes transmitting, to a UE, a resource allocation for a reference signal, wherein the resource allocation for the reference signal comprises an SBFD symbol and a non-SBFD symbol that are within a single slot; and communicating with the UE in accordance with the resource allocation.

In some aspects, an apparatus for wireless communication at a UE includes one or more memories; and one or more processors, coupled to the one or more memories, configured to cause the UE to: receive a resource allocation for a reference signal, wherein the resource allocation for the reference signal comprises an SBFD symbol and a non-SBFD symbol that are within a single slot; and communicate with a network node in accordance with the resource allocation.

In some aspects, an apparatus for wireless communication at a network node includes one or more memories; and one or more processors, coupled to the one or more memories, configured to cause the network node to: transmit, to a UE, a resource allocation for a reference signal, wherein the resource allocation for the reference signal comprises an SBFD symbol and a non-SBFD symbol that are within a single slot; and communicate with the UE in accordance with the resource allocation.

In some aspects, a non-transitory computer-readable medium storing a set of instructions for wireless communication includes one or more instructions that, when executed by one or more processors of a UE, cause the UE to: receive a resource allocation for a reference signal, wherein the resource allocation for the reference signal comprises an SBFD symbol and a non-SBFD symbol that are within a single slot; and communicate with a network node in accordance with the resource allocation.

In some aspects, a non-transitory computer-readable medium storing a set of instructions for wireless communication includes one or more instructions that, when executed by one or more processors of a network node, cause the network node to: transmit, to a UE, a resource allocation for a reference signal, wherein the resource allocation for the reference signal comprises an SBFD symbol and a non-SBFD symbol that are within a single slot; and communicate with the UE in accordance with the resource allocation.

In some aspects, an apparatus for wireless communication includes means for receiving a resource allocation for a reference signal, wherein the resource allocation for the reference signal comprises an SBFD symbol and a non-SBFD symbol that are within a single slot; and means for communicating with a network node in accordance with the resource allocation.

In some aspects, an apparatus for wireless communication includes means for transmitting, to a UE, a resource allocation for a reference signal, wherein the resource allocation for the reference signal comprises an SBFD symbol and a non-SBFD symbol that are within a single slot; and means for communicating with the UE in accordance with the resource allocation.

Aspects of the present disclosure may generally be implemented by or as a method, apparatus, system, computer program product, non-transitory computer-readable medium, user equipment, base station, network node, network node, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network.

FIG. 3 is a diagram illustrating an example disaggregated base station architecture in accordance with the present disclosure.

FIG. 4 is a diagram illustrating an example associated with full duplex communications, in accordance with the present disclosure.

FIG. 5 is a diagram illustrating examples of full duplex communication in a wireless network, in accordance with the present disclosure.

FIGS. 6A and 6B are diagrams illustrating an example of a channel state information reference signal port mapping, in accordance with the present disclosure.

FIG. 7 is a diagram illustrating an example of antenna configurations, in accordance with the present disclosure.

FIG. 8 is a diagram illustrating example of reference signal resource allocations, in accordance with the present disclosure.

FIG. 9 is a diagram illustrating an example of communications between a network node and UE, in accordance with the present disclosure.

FIG. 10 is a diagram illustrating an example of a reference signal resource allocation, in accordance with the present disclosure.

FIG. 11 is a diagram illustrating an example of communications between a network node and a UE, in accordance with the present disclosure.

FIG. 12 is a diagram illustrating an example process performed, for example, at a UE or an apparatus of a UE, in accordance with the present disclosure.

FIG. 13 is a diagram of an example apparatus for wireless communication, in accordance with the present disclosure.

FIG. 14 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or numbers of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some wireless communication networks, wireless communication devices may exchange reference signals, which may enable the wireless communication devices to perform channel estimation and improve a reliability of communications exchanged between the wireless communication devices. For example, a first wireless communication device (e.g., a network node) may transmit a channel state information reference signal (CSI-RS) to a second wireless device (e.g., a user equipment (UE)). Here, the second wireless communication device may perform one or more measurements on the received CSI-RS to identify channel state information (CSI) associated with downlink communications from the first wireless device. In another example, the second wireless communication device may transmit a sounding reference signal (SRS) to the first wireless communication device. Here, the first wireless communication device may perform one or more measurements on the received SRS to identify CSI associated with uplink communications from the second wireless communication device.

Prior to transmission of a reference signal, a network node may transmit a resource allocation to a UE that indicates one or more resources in a slot for the reference signal transmission. In some cases, the resource allocation for the reference signal may include both a symbol in the slot that is configured for full duplex communications (e.g., a sub-band full duplex (SBFD) symbol) and a symbol in the slot that is not configured for full duplex communications (e.g., a non-SBFD symbol).

Various aspects relate generally communications between wireless communication devices when a resource allocation, in a slot, for a reference signal includes both the symbol configured for full duplex communications and the symbol that is not configured for full duplex communications (e.g., is configured for half duplex communications). For example, a wireless communication device may refrain from transmitting at least a portion of the reference signal, refrain from monitoring at least a portion of the resources allocated for the reference signal, perform partial CSI updates based on receiving at least a portion of the reference signal, or refrain from performing any CSI updates when the resource allocation for the reference signal includes both the SBFD symbol and the non-SBFD symbol. In some aspects, the communications between the wireless communication devices when the resource allocation for the reference signal includes both the SBFD symbol and the non-SBFD symbol may be based on whether the SBFD and the non-SBFD symbol are separated by a gap symbol, code-division multiplexing (CDM) groups associated with the reference signal, ports associated with the reference signal, other configurations associated with the reference signal, or a combination thereof.

Particular aspects of the subject matter described in this disclosure can be implemented to realize one or more of the following potential advantages. In some examples, the wireless communication devices exchanging reference signals in at least some instances when a resource allocation for a reference signal includes both the symbol configured for full duplex communications and the symbol that is not configured for full duplex communications may improve a reliability of communications exchanges between the wireless communication devices (e.g., as compared to instances where the wireless communication devices do not exchange reference signals when the resource allocation for the reference signal include both the symbol configured for full duplex communications and the symbol that is not configured for full duplex communications). Additionally, configuring conditions and signaling associated with instances when the resource allocation for a reference signal includes both the symbol configured for full duplex communications and the symbol that is not configured for full duplex communications may improve coordination between wireless communication devices.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

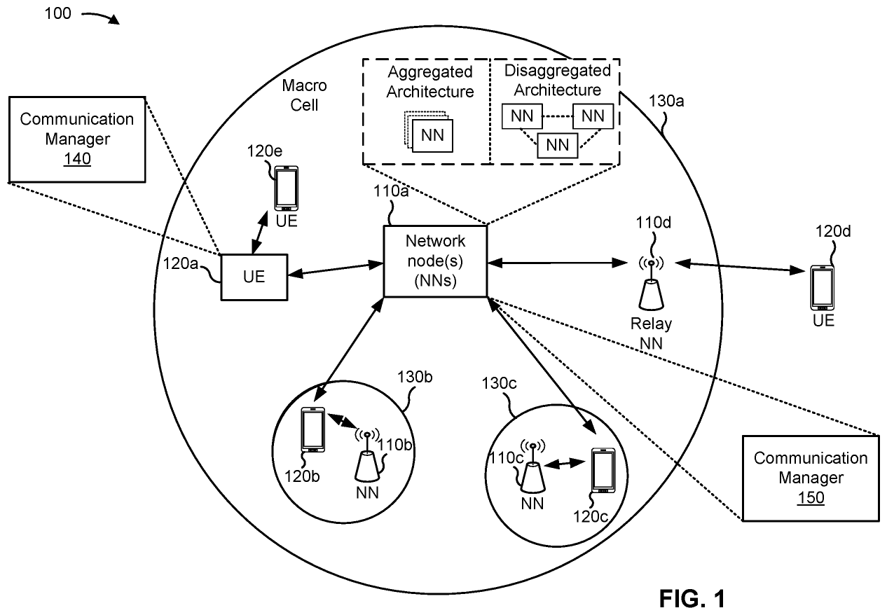

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHz), FR3 (7.125 GHz through 24.25 GHZ), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the number of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full duplex mode can transmit and receive communications concurrently (for example, in the same time resources). By operating in a full duplex mode, network nodes 110 and/or UEs 120 may generally increase the capacity of the network and the radio access link. In some examples, full duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full duplex operation may be enabled for a UE 120 but not for a network node 110. For example, a UE 120 may simultaneously transmit an UL transmission to a first network node 110 and receive a DL transmission from a second network node 110 in the same time resources. In some other examples, full duplex operation may be enabled for a network node 110 but not for a UE 120. For example, a network node 110 may simultaneously transmit a DL transmission to a first UE 120 and receive an UL transmission from a second UE 120 in the same time resources. In some other examples, full duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive a resource allocation for a reference signal, wherein the resource allocation for the reference signal comprises an SBFD symbol and a non-SBFD symbol that are within a single slot; and communicate with a network node in accordance with the resource allocation. Additionally, or alternatively, the communication manager 140 may perform one or more other operations described herein.

In some aspects, the network node 110 may include a communication manager 150. As described in more detail elsewhere herein, the communication manager 150 may transmit, to a UE, a resource allocation for a reference signal, wherein the resource allocation for the reference signal comprises an SBFD symbol and a non-SBFD symbol that are within a single slot; and communicate with the UE in accordance with the resource allocation. Additionally, or alternatively, the communication manager 150 may perform one or more other operations described herein.

As indicated above, FIG. 1 is provided as an example. Other examples may differ from what is described with regard to FIG. 1.

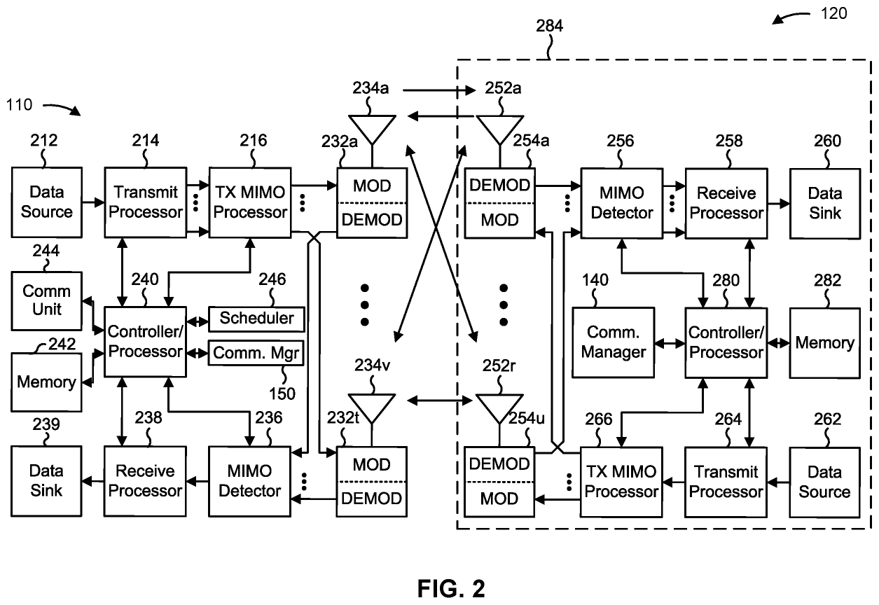

FIG. 2 is a diagram illustrating an example network node 110 in communication with an example UE 120 in a wireless network.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a CSI-RS) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The number of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

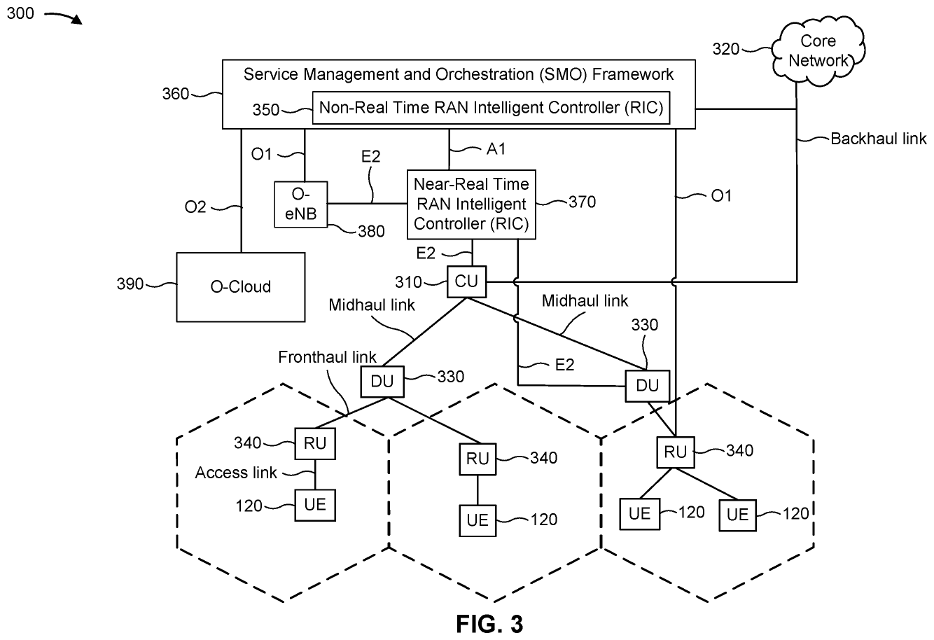

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUS 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

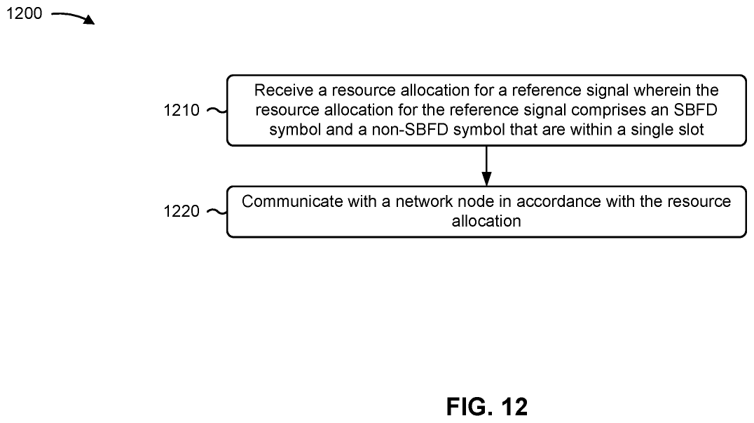

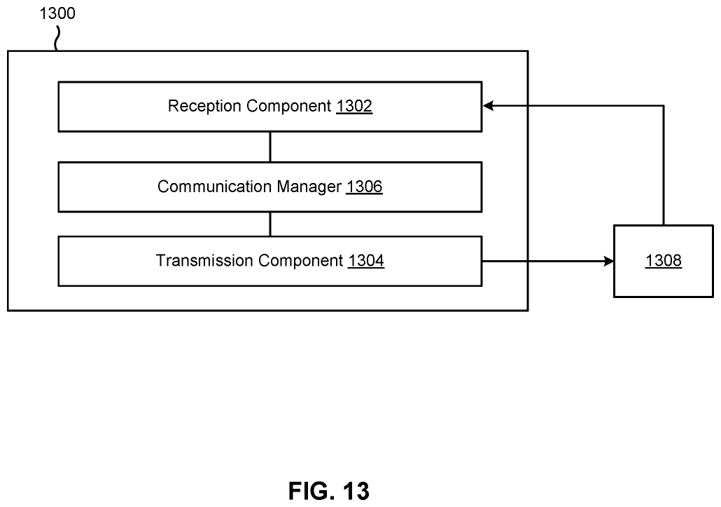

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with communicating based on reference signal allocations, as described in more detail elsewhere herein. For example, the controller/processor 240 of the network node 110, the controller/processor 280 of the UE 120, any other component(s) (or combinations of components) of FIG. 2, the CU 310, the DU 330, or the RU 340 may perform or direct operations of, for example, process 1200 of FIG. 12 or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1200 of FIG. 12, process 1300 of FIG. 13, or other processes as described herein. In some examples, executing instructions may include running the instructions, converting the instructions, compiling the instructions, and/or interpreting the instructions, among other examples.

In some aspects, the UE includes means for receiving a resource allocation for a reference signal, wherein the resource allocation for the reference signal comprises an SBFD symbol and a non-SBFD symbol that are within a single slot; and/or means for communicating with a network node in accordance with the resource allocation. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for transmitting, to a UE, a resource allocation for a reference signal, wherein the resource allocation for the reference signal comprises an SBFD symbol and a non-SBFD symbol that are within a single slot; and/or means for communicating with the UE in accordance with the resource allocation. The means for the network node to perform operations described herein May include, for example, one or more of communication manager 150, transmit processor 220, TX MIMO processor 230, modem 232, antenna 234, MIMO detector 236, receive processor 238, controller/processor 240, memory 242, or scheduler 246.

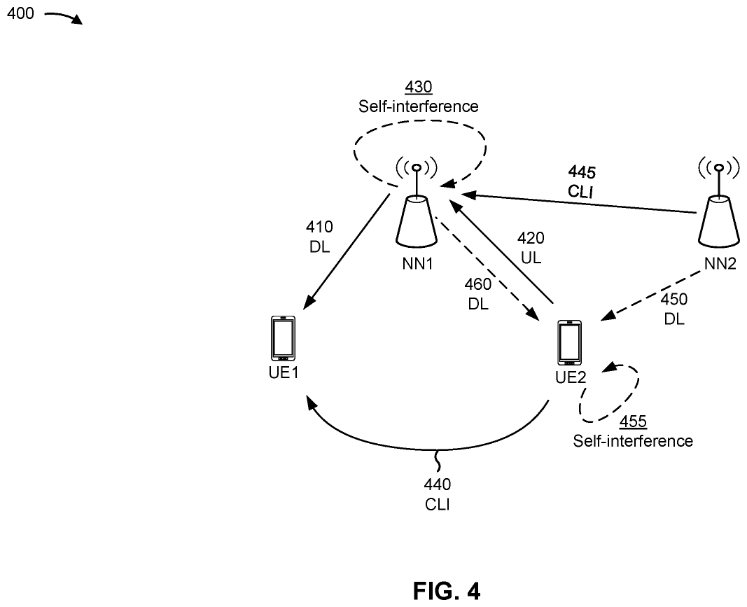

FIG. 4 is a diagram illustrating an example 400 associated with full duplex communications, in accordance with the present disclosure. As shown, example 400 includes multiple wireless communication devices, including an NN1 (e.g., a network node, such as NN 110), an NN2 (e.g., another network node, such as NN 110), a UE1 (e.g., UE 120), and a UE2 (e.g., another UE 120). In some aspects, one or more of the wireless communication devices may be capable of full duplex communications. “Full duplex communication” in a wireless network refers to simultaneous bi-directional communication between devices in the wireless network. For example, a UE operating in a full duplex mode may transmit an uplink communication and receive a downlink communication at the same time (e.g., in the same slot or the same symbol). Full duplex communication may include a contemporaneous uplink and downlink communication using the same resources (e.g., using the same resources in a time domain). For example, full duplex communications may include a wireless device transmitting one communication via a first set of resources and receiving another communication via a second set of resources, where the first set of resources and the second set of resources at least partially overlap in a time domain. “Half duplex communication” in a wireless network refers to unidirectional communications (e.g., only downlink communication or only uplink communication) between devices at a given time (e.g., in a given slot or a given symbol).

In one example, the NN1 may perform a downlink transmission DL 410 to a UE1 and may receive an uplink transmission UL 420 from a UE2 using the same frequency resources and at least partially overlapping in time, which may correspond to full duplex communications. In this example, the NN1 may correspond to a full duplex network node, and the UE1 and UE2 may correspond to half duplex UEs (e.g., the UE2 may not receive the downlink transmission DL 450 or DL 460).

In another example, the UEs UE1 and UE2 may also perform full duplex communications. In one case, the UE2 may transmit the uplink transmission UL 420 to the NN1 during a first time period that at least partially overlaps in time with a second time period when the UE2 is receiving a downlink transmission DL 450 from the NN2. In another case, the UE2 may perform full duplex communications by transmitting the uplink transmission UL 420 to the NN1 during a first time period that at least partially overlaps in time with a second time period when the UE2 is receiving a downlink transmission DL 460 from the NN1.

As shown by reference number 430, the downlink transmission DL 410 from the NN1 may self-interfere with the uplink transmission UL 420 to the NN1. This may be caused by a variety of factors, such as the higher transmit power for the downlink transmission DL 410 (as compared to the uplink transmission UL 420) and/or radio frequency bleeding. Furthermore, as shown by reference number 440, the uplink transmission UL 420 to the NN1 from the UE2 may interfere (e.g., via cross link interference (CLI)) with the downlink transmission DL 410 from the NN1 to the UE1, thereby diminishing downlink performance of the UE1. Furthermore, as shown by reference number 445, transmissions from the NN2 may interfere (e.g., via CLI) with transmissions to and from the NN1. Additionally, as shown by reference number 455, the downlink transmission 450 from the NN2 may self-interfere with the uplink transmission UL 420 to the NN1 (e.g., at the UE2).

In some instances of full duplex communications, a network node (e.g., NN1, NN2) may transmit a resource allocation to a UE (e.g., UE1, UE2) that indicates one or more resources in a slot for the reference signal transmission, and the resource allocation for the reference signal may include both a symbol configured for full duplex communications (e.g., an SBFD symbol) and a symbol that is not configured for full duplex communications (e.g., a non-SBFD symbol). In the example 400, a UE or network node may refrain from transmitting at least a portion of the reference signal, refrain from monitoring at least a portion of the resources allocated for the reference signal, perform partial CSI updates based on receiving at least a portion of the reference signal, or refrain from performing any CSI updates when the resource allocation for the reference signal includes both the SBFD symbol and the non-SBFD symbol. In some aspects, the communications between the UEs and network nodes when the resource allocation for the reference signal includes both the SBFD symbol and the non-SBFD symbol may be based on whether the SBFD and the non-SBFD symbol are separated by a gap symbol, CDM groups associated with the reference signal, ports associated with the reference signal, other configurations associated with the reference signal, or a combination thereof.

As indicated above, FIG. 4 is provided as an example. Other examples may differ from what is described with respect to FIG. 4.

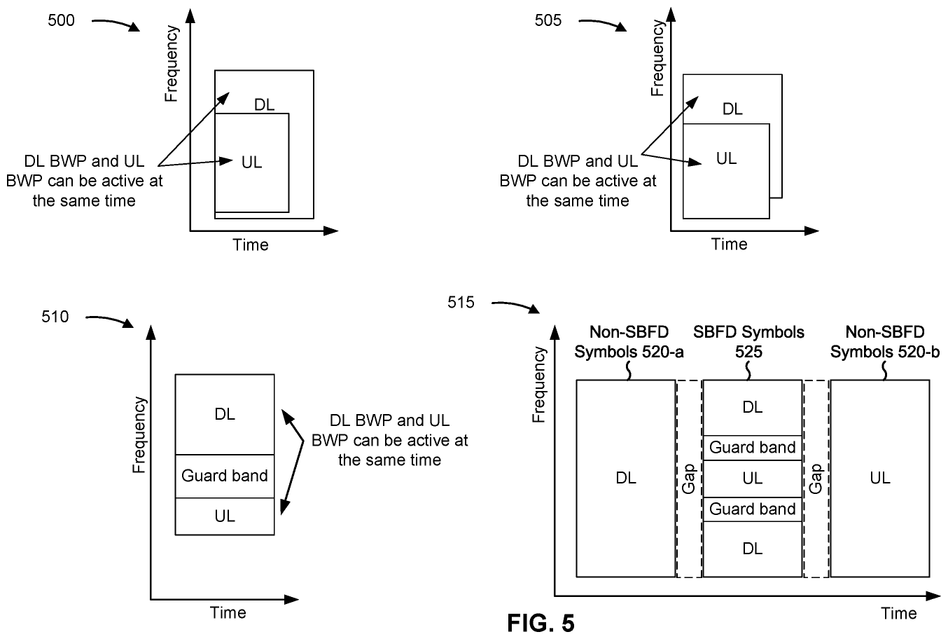

FIG. 5 is a diagram illustrating examples 500, 505, 510, and 515 of full duplex communication in a wireless network, in accordance with the present disclosure.

As shown in FIG. 5, examples 500 and 505 show examples of in-band full duplex (IBFD) communication. In IBFD, a UE may transmit an uplink communication to a network node and receive a downlink communication from a network node (e.g., from the same network node or from another network node) on resources that at least partially overlap in both the time and frequency domain (e.g., on at least some of the same time and frequency resources). As shown in example 500, in a first example of IBFD, the time and frequency resources for uplink communication may fully overlap with the time and frequency resources for downlink communication. As shown in example 505, in a second example of IBFD, the time and frequency resources for uplink communication may partially overlap with the time and frequency resources for downlink communication.

As further shown in FIG. 5, example 510 shows an example of SBFD communication, which may also be referred to as “sub-band frequency division duplex (SBFDD)” or “flexible duplex.” In SBFD, a UE may transmit an uplink communication to a network node and receive a downlink communication from the network node at the same time, but on different frequency resources. For example, the different frequency resources may be sub-bands of a frequency band, such as a time division duplexing band. In this case, the frequency resources used for downlink communication may be separated from the frequency resources used for uplink communication, in the frequency domain, by a guard band.

As shown in FIG. 5, example 515 shows an example of SBFD. The example 515 may illustrate a first non-SBFD symbol 520-a (e.g., a symbol that is configured for half duplex communications, such as downlink communications), an SBFD symbol 525 (e.g., a symbol that is configured for SBFD communications), and a second non-SBFD symbol 520-b (e.g., a symbol that is configured for half duplex communications, such as uplink communications).

A wireless communication device (e.g., a network node, a UE) may utilize a transition time between non-SBFD symbols 520 and SBFD symbols 525 to adjust one or more transmission or reception configurations at the wireless communication device between full duplex and half duplex symbols. In one example, there may be a gap symbol configured to extend, in a time domain, between a non-SBFD symbol 520 and an SBFD symbol 525. In another example, the transition time may be contained in a cyclic prefix in a second symbol. That is, in the case of the transition from the non-SBFD symbol 520-a to the SBFD symbol 525, the transition time may be contained in the cyclic prefix of the SBFD symbol 525. Additionally, in the case of the transition from the SBFD symbol 525 to the non-SBFD symbol 520-b, the transition time may be contained in the cyclic prefix of the non-SBFD symbol 520-b.

In examples 510 or 515, a network node may transmit a resource allocation to a UE that indicates one or more resources in a slot for the reference signal transmission to UEs that are SBFD-aware (e.g., that are configured to perform full duplex communications via one or more SBFD symbols 525). For example, the resource allocation may be for a CSI-RS across downlink subbands and may include both a symbol configured for full duplex communications (e.g., an SBFD symbol 525) and a symbol that is not configured for full duplex communications (e.g., a non-SBFD symbol 520). In a first case, the resource allocation may indicate two contiguous CSI-RS resources (e.g., that are contiguous in a time domain) and that are linked. In a second case, the resource allocation may indicate a single CSI-RS resource. Here, the single CSI-RS resource may include a non-contiguous CSI-RS resource allocation or the single CSI-RS resource may include one contiguous CSI-RS resource allocation and the UE may derive a non-contiguous CSI-RS by excluding frequency resources outside of the downlink subbands (e.g., in the SBFD symbol 525).

In both cases, the network node may generate the CSI-RS sequence independently of the resource allocation including both the non-SBFD symbol 520 and the SBFD symbol 525. Additionally, in the first case when the resource allocation for the CSI-RS indicates two contiguous CSI-RS resources, the network node may additionally transmit signaling that indicates that the two CSI-RS resources are linked in the two downlink subbands (e.g., of the SBFD symbol 525). Furthermore, in the second case when the resource allocation for the CSI-RS indicates a non-contiguous CSI-RS resource allocation, the network node may transmit signaling (e.g., via RRC) that configures non-contiguous resource blocks for the one CSI-RS resource.

When the resource allocation includes both a non-SBFD symbol 520 and the SBFD symbol 525, the UE may transmit a CSI report that is based on the resource allocation including both the non-SBFD symbol 520 and the SBFD symbol 525. In one example, when the non-SBFD symbols 520 and the SBFD symbols 525 are in different slots (e.g., each CSI-RS resource within a slot has either all SBFD or all non-SBFD symbols), the UE may perform separate CSI reporting for SBFD symbols 525 and for non-SBFD symbols 520, or the UE may perform a same CSI reporting for SBFD symbols 525 and non-SBFD symbols 520. In another example, when the non-SBFD symbols 520 and the SBFD symbols 525 are in the same slots (e.g., each CSI-RS resource within a slot has both an SBFD symbol 525 and a non-SBFD symbols 520), the UE may perform separate CSI reporting for SBFD symbols 525 and for non-SBFD symbols 520 (but for a same slot) or the UE may perform a same CSI reporting for SBFD symbols 525 and non-SBFD symbols 520.

As indicated above, FIG. 5 is provided as an example. Other examples may differ from what is described with respect to FIG. 5.

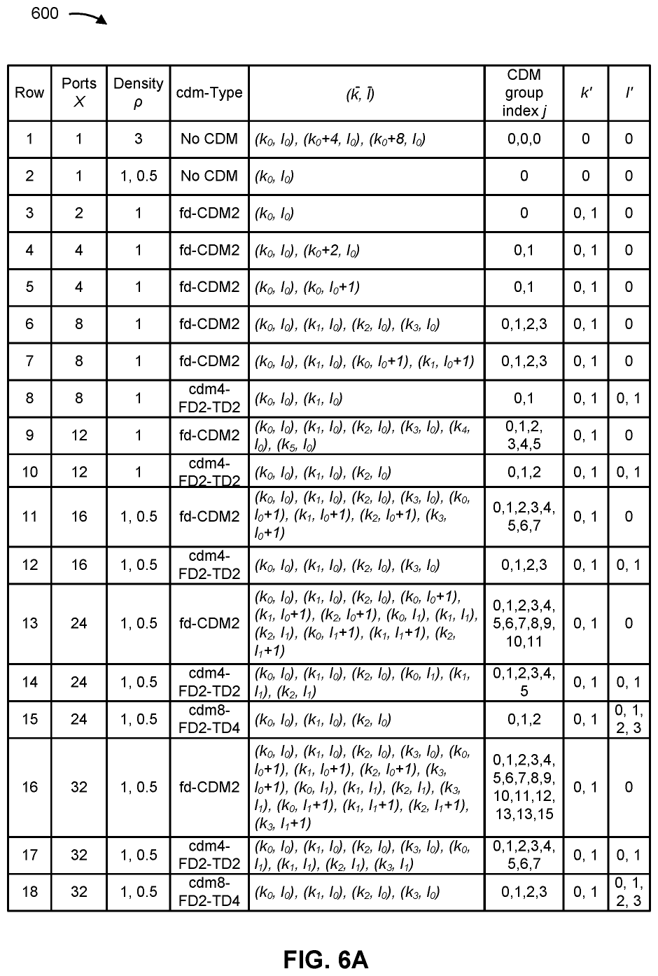

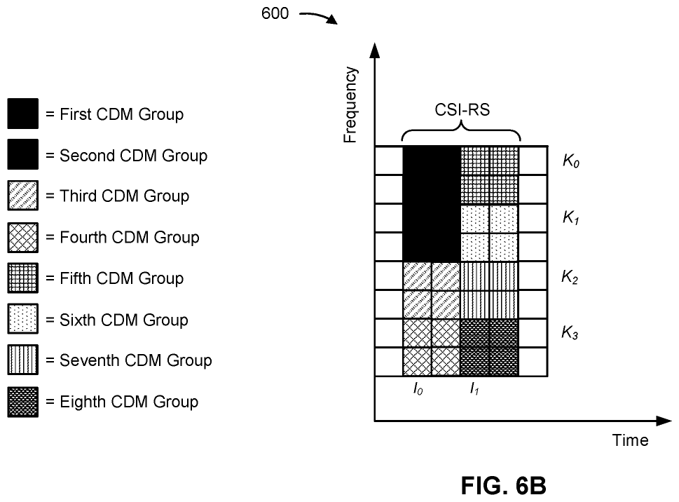

FIGS. 6A and 6B are diagrams illustrating an example 600 of a CSI-RS port mapping, in accordance with the present disclosure. The CSI-RS port mapping may also be referred to as a CSI-RS resource mapping.

A CSI-RS may be based at least in part on a pseudo random sequence. For each CSI-RS that is configured, a UE may assume that a sequence is mapped to one or more REs. The mapping may be based at least in part on one or more parameters indicated by a CSI configuration (e.g., a CSI-RS-ResourceMapping information element (IE)) and/or another RRC configuration. The mapping of CSI-RS sequences to REs (e.g., to time-frequency resources) may be defined, or otherwise fixed, by a wireless communication standard, such as the 3GPP (e.g., 3GPP Technical Specification 38.211 Version 16.7.0 may define the mapping of CSI-RS sequences to REs). For example, as shown in FIG. 6A, the mapping may be based at least in part on a number of configured CSI-RS ports (e.g., which may be referred to as “Ports X”), a density (p), a CDM type, one or more time domain and frequency domain locations (e.g., for a CDM group) (e.g., which may be referred to as (k̅, l̅), where k is a frequency domain resource location reference point and l is a time domain resource location reference point), a CDM group index (j), a frequency domain index within a CDM group (k′), and/or a time domain index within a CDM group (l′), among other examples. For example, 3GPP Technical Specification 38.211 provides a table with different entries (e.g., identified by a row index value) defining different CSI-RS resource locations for different values of the parameters described above.

The number of configured CSI-RS ports (e.g., Ports X) may be given by a higher layer (e.g., RRC) parameter, such as an nrofPorts parameter in a CSI-RS-ResourceMapping IE. The number of configured CSI-RS ports may be a number of CSI-RS ports configured for (e.g., available for use) by the network node 110. The density (p) may be given by a higher layer (e.g., RRC) parameter, such as a density parameter in the CSI-RS-ResourceMapping IE or in a CSI-RS-CellMobility IE. The density may indicate a number of CSI-RSs that are transmitted per-RB. For example, a density of 1 (one) may indicate that one CSI-RS is transmitted in each RB. A density of 0.5 may indicate that one CSI-RS is transmitted in every other RB (e.g., every 2 RBs).

The CDM types may indicate a pattern associated with CDM groups associated with the CSI-RS transmission. For example, in a wireless communication system, multiple CSI-RS ports can be used to transmit on the same OFDM symbol using CDM and frequency division multiplexing (FDM). Using FDM, different CSI-RS ports can be used for transmission of CSI-RSs on the same OFDM symbol by using different sub-carriers (e.g., tones or REs) for different CSI-RS ports. Using CDM, different CSI-RS ports can be used for transmission of CSI-RSs on the same OFDM symbol (or across a set of OFDM symbols on the same subcarrier) by using different orthogonal cover codes (OCCs) for different CSI-RS ports. The CSI-RS ports that are used for transmission on the same sub-carrier belong to the same CDM group, and the CSI-RS ports that are used for transmission on different sub-carriers belong to different CDM groups. In other words, a CDM group includes a set of CSI-RS ports used for transmission of a respective set of CSI-RSs on the same sub-carrier, where different OCCs are used for (e.g., to scramble) transmissions on different CSI-RS ports included in the set of CSI-RS ports.

In cases where the CDM type corresponds to TDM2, the CDM group is associated with two symbols (e.g., spans two symbols in a time domain). Additionally, in cases where the CDM type corresponds to TDM4, the CDM group is associated with four symbols (e.g., spans four symbols in the time domain).

The one or more time domain and frequency domain locations (e.g., for a CDM group) ((k̅, l̅)) may provide starting locations for each CDM group in the time domain (I) and the frequency domain (k̅) for each CDM group associated with the CSI-RS transmission. A reference point for k=0 may be a subcarrier with an index value of “0” in common RB 0. Different k̅ values (e.g., k₀, k₁, k₂, and/or k₃) may be provided by a frequency domain resource allocation (e.g., a frequencyDomainAllocation parameter) in the CSI-RS-ResourceMapping IE or a CSI-RS-ResourceConfigMobility IE. Different l̅ values (e.g., l₀, and/or l₁) may be provided by a higher layer (e.g., RRC) parameter indicating a first OFDM symbol in the time domain for a CSI-RS (e.g., by a firstOFDMSymbolInTime Domain parameter (e.g., for l₀) or a firstOFDMSymbolInTime Domain2 parameter (e.g., for l₁) in the CSI-RS-ResourceMapping IE or the CSI-RS-ResourceConfigMobility IE). The frequency domain index within a CDM group (k′) and the time domain index within a CDM group (l′) may provide RE indices for a given CDM group (e.g., relative to the k̅, l̅ values).

FIG. 6B depicts a CSI-RS resource mapping associated with 32 CSI-RS ports (e.g., a Ports X value of 32) and 8 CDM groups. For example, the example 600 may depict a CSI-RS resource mapping corresponding to row 17 of the table depicted in FIG. 6A. For example, the example 600 may be associated with a Ports X value of 32, a density of 1 or 0.5, a CDM type of cdm8-FD2-TD4, and k̅, l̅ values of (k₀, l₀) (e.g., for the first CDM group), (k₁, l₀) (e.g., for the second CDM group), (k₂, l₀) (e.g., for the third CDM group), (k₃, l₀) (e.g., for the fourth CDM group), (k₀, l₁) (e.g., for the fifth CDM group), (k₁, l₁) (e.g., for the sixth CDM group), (k₂, l₁) (e.g., for the seventh CDM group), and (k₃, l₁) (e.g., for the eighth CDM group). The example 600 may be associated with k′ values of 0 and 1 (e.g., indicating that each CDM group includes an RE with index k̅ and an RE with index k̅+1). The example 600 may be associated with l′ values of 0, and 1 (e.g., indicating that each CDM group includes an RE with index l̅, and l̅+1). Based at least in part on the higher layer parameters configured for the CSI-RS, a UE may identify the CSI-RS time-frequency locations (e.g., in a similar manner as described above).

In some instances of full duplex communications, a network node may transmit a resource allocation to a UE that indicates for the UE to monitor REs in a slot that are in both an SBFD symbol and a non-SBFD symbol. For example, FIG. 6B illustrates an example 600 of a CSI-RS resource allocation where the first, second, third, and fourth CDM groups are associated with an SBFD symbol and the fifth, sixth, seventh, and eighth CDM groups are associated with a non-SBFD symbol. Based on the CSI-RS resource allocation including REs in both an SBFD and a non-SBFD symbol, the UE or network node may refrain from transmitting at least a portion of the reference signal, refrain from monitoring at least a portion of the resources allocated for the reference signal, perform partial CSI updates based on receiving at least a portion of the reference signal, or refrain from performing any CSI updates when the resource allocation for the reference signal includes both the SBFD symbol and the non-SBFD symbol. In some aspects, the communications between the UEs and network nodes when the resource allocation for the reference signal includes both the SBFD symbol and the non-SBFD symbol may be based on whether the SBFD and the non-SBFD symbol are separated by a gap symbol, CDM groups associated with the reference signal, ports associated with the reference signal, other configurations associated with the reference signal, or a combination thereof.

As indicated above, FIGS. 6A and 6B are provided as examples. Other examples may differ from what is described with regard to FIG. 6.

As indicated above, FIG. 6 is provided as one or more examples. Other examples are possible and may differ from what is described with regard to FIG. 6.

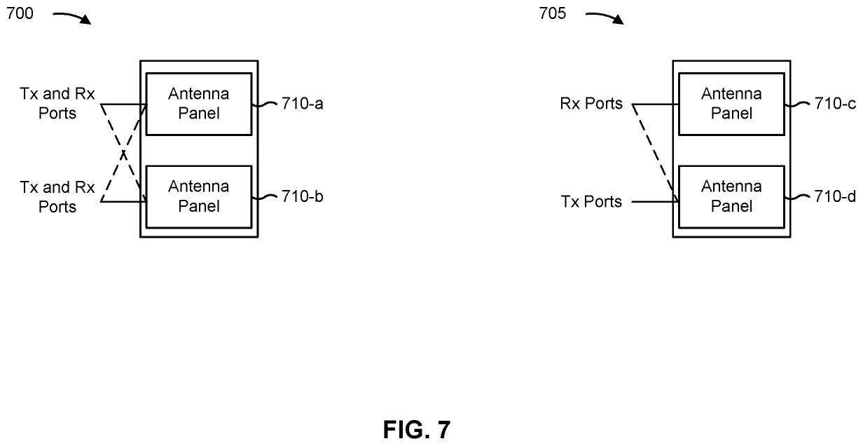

FIG. 7 is a diagram illustrating an example 700 of antenna configurations, in accordance with the present disclosure.

As shown in FIG. 7, examples 700 and 705 show examples of antenna configurations, which can be used for transmissions via both SBFD symbols and non-SBFD symbols (e.g., half duplex symbols such as TDD downlink and/or uplink symbols). For example, a network node may employ one of the antenna configurations illustrated by example 700 and 705 for transmitting and/or receiving communications via an SBFD symbol or a non-SBFD symbol. The example antenna configurations both relate to various mappings of transmission (Tx) ports and reception (Rx) ports to antenna panels 710 at the wireless communication device.

Example 700 illustrates an antenna configuration where the Tx and Rx ports are both split between the multiple antenna panels 710-a and 710-b. Additionally, example 705 illustrates an antenna configuration where the Rx ports are mapped to one antenna panel 710-c and the Tx ports are mapped to another antenna panel 710-d.

In some cases and based on the antenna configuration of the network node, the network node may communicate via a different number of ports based on whether the network node is communicating via an SBFD or a non-SBFD. For example, when the antenna configuration illustrated by example 700 includes fixed virtualization (e.g., the ports are mapped to either the panel 710-a or 710-b, but not mapped to both), the network node may communicate using half the number of ports in an SBFD symbol as compared to a non-SBFD symbol.

Additionally, in some cases a transmission power associated with each of the transmission ports may be different based on whether the network node is communicating via an SBFD symbol or a non-SBFD symbol. For example, when the network node is communicating using antenna panels configured as illustrated in example 700, the Tx ports may be associated with a lower transmission power for communications via an SBFD symbol as compared to communications transmitted via a non-SBFD symbol.

Based on differences in communications when the network node is communicating via an SBFD and a non-SBFD, communications via resource allocations that include both an SBFD symbol and a non-SBFD symbol may be impacted. Accordingly, the communications between the UEs and network nodes when the resource allocation for the reference signal includes both the SBFD symbol and the non-SBFD symbol may be based on whether the SBFD and the non-SBFD symbol are separated by a gap symbol, CDM groups associated with the reference signal, ports associated with the reference signal, other configurations associated with the reference signal, or a combination thereof.

As indicated above, FIG. 7 is provided merely as an example. Other examples may differ from what is described with regard to FIG. 7.

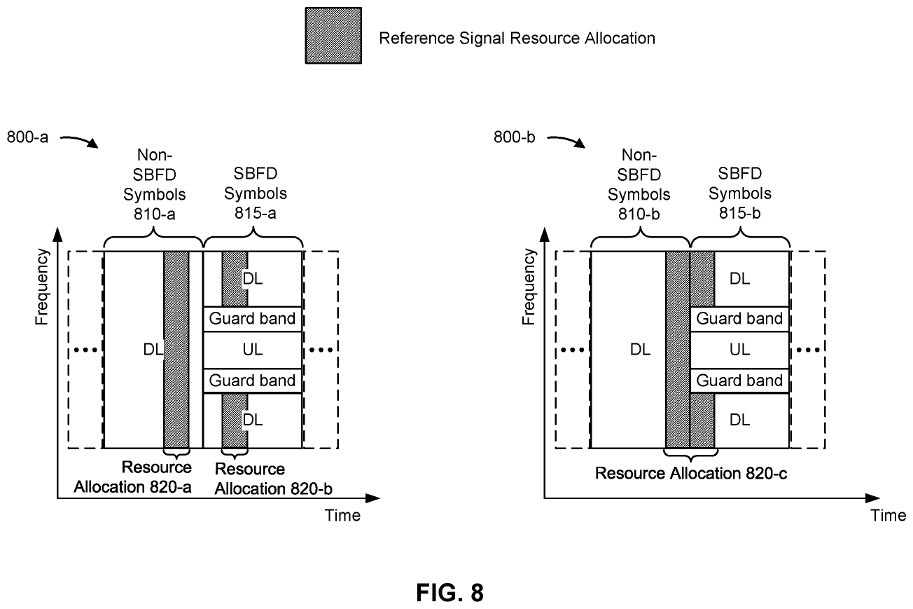

FIG. 8 is a diagram illustrating an example 800 of reference signal resource allocations that include resources in both an SBFD symbol 815 and a non-SBFD symbol 810, in accordance with the present disclosure. In the examples 800-a and 800-b, the reference signal resource allocations may have occasions in both non-SBFD symbols 810 and SBFD symbols 815 (e.g., within a single slot). While not illustrated by examples 800, in some cases there may be a gap symbol that extends between the non-SBFD symbols 810 and the SBFD symbols 815.

A network node (e.g., a network node 110) may transmit signaling indicating a resource allocation for a reference signal transmission (e.g., a CSI-RS reference signal). In some cases, the resource allocation may include periodic, semi-persistent, or aperiodic resource allocations for the reference signal. In some examples, the resource allocation for the reference signal may additionally indicate a number of ports associated with each symbol. For example, the resource allocation may indicate that the reference signal is mapped to a first number of first ports in the SBFD symbol 815 and mapped to a second number of second ports in the non-SBFD symbol 810.

Example 800-a illustrates a case where the reference signal resource allocation corresponds to resource allocation 820-a and 820-b, where the resource allocation 820-a includes one or more non-SBFD symbols 810-a (e.g., one or more symbols configured for half duplex downlink communications) and the resource allocation 820-b includes one or more SBFD symbols 815-a (e.g., one or more symbols that are configured for full duplex communications). In some cases, the example 800-a may correspond to a reference signal resource allocation associated with a CDM type associated with TDM2, where the resource allocation 820-a includes CDM groups spanning two non-SBFD symbols 810-a and the resource allocation 820-b includes CDM groups spanning two SBFD symbols 815-a. Example 800-b illustrates a case where the reference signal resource allocation corresponds to the resource allocation 820-c. In some cases, the example 800-b May correspond to a reference signal resource allocation associated with a CDM type associated with TDM4, where the resource allocation 820-c includes CDM groups spanning four symbols: two non-SBFD symbols 810-b and two SBFD symbols 815-b.

In some cases, the network node and/or UE may perform communications in response to the non-SBFD symbols 810 and the SBFD symbols 815 that are included in the reference signal resource allocation being configured to have the same number of ports. For example, in cases where reference signal resource allocation configures two reference signal resources (e.g., two CSI-RS resources), and one of the configured reference signal resources is for SBFD (e.g., includes at least one SBFD symbol 815) and one of the configured reference signal resources is for non-SBFD (e.g., includes at least one non-SBFD symbol 810), then any resource that crosses a symbol boundary between SBFD symbols 815 and non-SBFD symbols 810 may be dropped (e.g., the network node may refrain from transmitting reference signals via resources that cross the symbol boundary, the UE may refrain from monitoring resources that cross the symbol boundary).

In other cases, where the non-SBFD symbols 810 and the SBFD symbols 815 are configured to have the same number of ports, the reference signal resource allocation may be prohibited from configuring (e.g., via periodic, semi-persistent, or aperiodic scheduling) a single reference signal resource (e.g., one CSI-RS resource) that has occasions in a non-SBFD symbol 810 and an SBFD symbol 815. In some other cases, the network node may avoid configuring reference signal resource allocations that include non-SBFD and SBFD symbols 810 and 815 via aperiodic scheduling, but may configure reference signal resource allocations that include non-SBFD and SBFD symbols 810 and 815 via semi-persistent or periodic scheduling.

In some cases, where the non-SBFD symbols 810 and the SBFD symbols 815 are configured to have the same number of ports, the reference signal resource allocation may configure a single reference signal resource (e.g., one CSI-RS resource) having occasions in a non-SBFD symbol 810 and an SBFD symbol 815. Here, the network node may drop reference signal transmissions in cases where the reference signal resource allocation has occasions in the non-SBFD symbol 810 and the SBFD symbol 815. Additionally or alternatively, the UE may refrain from monitoring the resources (e.g., the non-SBFD and SBFD symbols 810 and 815).

In some other cases, where the non-SBFD symbols 810 and the SBFD symbols 815 are configured to have the same number of ports and the reference signal resource allocation configures a single reference signal resource (e.g., one CSI-RS resource) having occasions in a non-SBFD symbol 810 and an SBFD symbol 815, the UE may perform a partial CSI-RS update. In one example of the partial CSI-RS update, the UE may update non-SBFD CSI based on the CDM groups in the non-SBFD symbols 810, and the UE may update the SBFD CSI based on the CDM groups in the SBFD symbols 815. Accordingly, the UE may update a subset of the CSI-RS ports. For example, the UE may monitor the non-SBFD symbols 810 for a first subset of the CDM groups associated with the reference signal to determine a first channel estimation associated with non-SBFD communications. Additionally, the UE may monitor the SBFD symbols 815 for a second subset of CDM groups associated with the reference signal to determine a second channel estimation associated with SBFD communications. The UE may transmit a CSI report that corresponds to the first channel estimation and the second channel estimation. For example, the UE may transmit the CSI report that indicates one or more first CSI metrics (e.g., CQI, rank, etc.) that are computed based on the first channel estimation and/or one or more second CSI metrics that are computed based on the second channel estimation.

In another example of the partial CSI-RS update, the UE may update a subset of the ports by updating either the non-SBFD CSI or the SBFD CSI. In some cases, the network node may drop a subset of the CDM groups associated with the reference signal. For example, the network node may transmit the first subset of CDM groups that are in the non-SBFD symbols 810, but may drop the second subset of CDM groups that are in the SBFD symbols 815. Additionally, or alternatively, the UE may refrain from monitoring one of the subsets of the CDM groups associated with the reference signal (e.g., and monitoring either the non-SBFD symbols 810 or the SBFD symbols 815). In either example, the UE may update the CSI-RS for one type of CSI (e.g., for non-SBFD CSI) and transmit a CSI report that corresponds to a channel estimation associated with the one type of communication (e.g., the non-SBFD communications). For example, the UE may transmit the CSI report that indicates one or more CSI metrics (e.g., CQI, rank, etc.) that are computed based on a channel estimation associated with the one type of communication (e.g., the non-SBFD communications or the SBFD communications).

The UE may perform a partial CSI-RS update in cases where a set of conditions are satisfied. If any of the conditions in the set of conditions are not satisfied, the UE may refrain from monitoring the resources indicated by the resource allocation, and may not perform any CSI-RS updates (e.g., and may not transmit a corresponding CSI report). In some cases, a condition for the UE performing the partial CSI-RS update may be that the non-SBFD symbols 810 and the SBFD symbols 815 are configured to have the same number of ports. Another condition for the UE performing the partial CSI-RS update may include the resource allocation for the reference signal not overlapping with a gap symbol (e.g., if a gap symbol is configured) between the SBFD symbols 815 and the non-SBFD symbol 810.

Another condition for the UE performing the partial CSI-RS update may include each CDM group in the CSI-RS being in either SBFD symbols 815 or non-SBFD symbols 810 (e.g., corresponding to TDM2, illustrated in example 800-a). For example, in cases where a CDM group associated with the CSI-RS is included in both an SBFD symbol 815 and a non-SBFD symbol 810 (e.g., corresponding to TDM4, illustrated in example 800-b), the UE may not perform the partial CSI-RS update. Another condition for the UE performing the partial CSI-RS update may include the resource allocation for the reference signal indicating that the time restriction for the CSI report is not configured. For example, the network node may indicate (e.g., within a CSI report configuration) whether a time restriction (e.g., timeRestrictionForChannelMeasurmenets) is configured. If the time restriction is configured, the network node configures a one-shot CSI-reporting which may not be capable of supporting some ports being updated (e.g., since CDM groups are not all on a same symbol type). Therefore, if the time restriction is configured, the UE may not perform the partial CSI-RS update. Alternatively, if the time restriction is not configured, averaging for CSI reporting may be enabled and the UE may be capable of performing the partial CSI-RS update.

In some cases, the network node and/or the UE may perform communications in response to the non-SBFD symbols 810 and the SBFD symbols 815 that are included in the reference signal resource allocation being configured to have a different number of ports. For example, the number of CSI-ports that are active in SBFD symbols 815 may be half of the number of ports that are active in non-SBFD symbols 810. Here, a subset of CDM groups may be valid in SBFD symbols 815, but a remaining subset of the CDM groups may not be valid in the non-SBFD symbols 810. In cases where the ports in the CDM groups are valid in SBFD symbol 815, the UE may perform partial updates. However, partial updates may not be performed by the UE in this case based on the configuration of the CDM groups (e.g., and whether the resulting CDM groups in the SBFD symbol 815 are valid).

In the example 800-b, the reference signal resource allocation may include CDM groups that span a non-SBFD symbol 810-b and an SBFD symbol 815-b. In cases where the network node uses the same transmission parameters to transmit the reference signal within the non-SBFD symbols 810-b and the SBFD symbols 815-b (e.g., the same power spectral density, the same phase coherence), the UE may transmit, to the network node, a CSI report associated with a first channel estimation associated with SBFD communications and a second channel estimation associated with non-SBFD communications. For example, the UE may transmit the CSI report that indicates one or more first CSI metrics (e.g., CQI, rank, etc.) that are computed based on the first channel estimation and one or more second CSI metrics that are computed based on the second channel estimation.

In some cases, when transmitting the reference signal via the resource allocation 820-c, the network node may refrain from transmitting a portion of the reference signal in the non-SBFD symbol 810-b. For example, the network node may refrain from transmitting the reference signal in the non-SBFD symbol 810-b via resource elements in the non-SBFD symbols 810-b that overlap in the frequency domain with the guard bands and uplink channel allocation in the SBFD symbols 815-b. Alternatively, the network node may transmit the reference signal via the full resource allocation 820-c in the non-SBFD symbols 810-b, and the UE may refrain from monitoring a portion of the resource elements in the non-SBFD symbols 810-b. For example, the UE may refrain from monitoring the resource elements in the non-SBFD symbols 810-b that overlap in the frequency domain with the guard bands and uplink channel allocation in the SBFD symbols 815-b.

As indicated above, FIG. 8 is provided as an example. Other examples may differ from what is described with respect to FIG. 8.

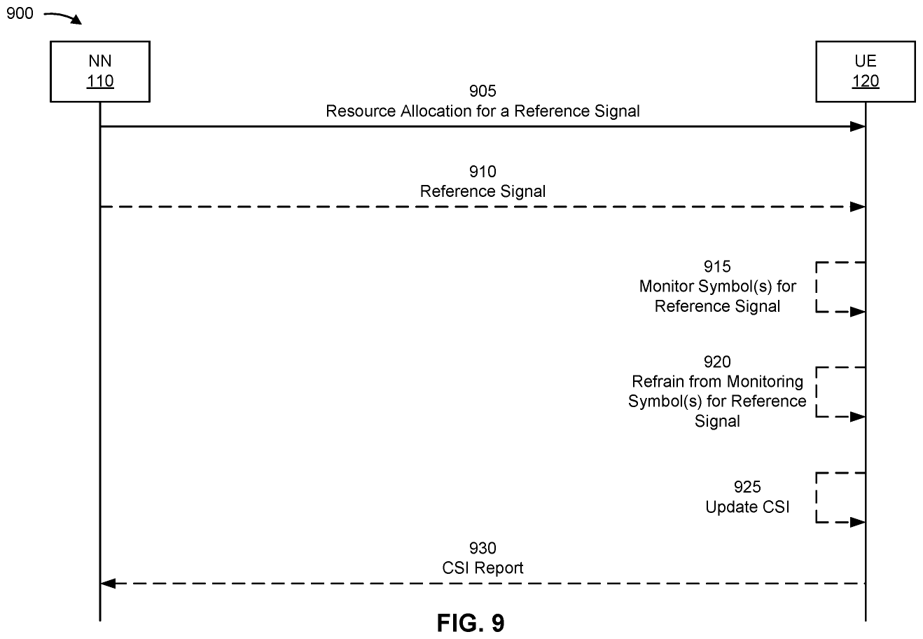

FIG. 9 is a diagram illustrating an example 900 of communications between a network node 110 and UE 120, in accordance with the present disclosure.

As shown by reference number 905, the network node 110 may transmit a resource allocation for a reference signal (e.g., a CSI-RS). In some cases, the network node 110 may transmit signaling indicating a resource allocation illustrated by example 800-a or 800-b, as described with reference to FIG. 8. The resource allocation may include at least one SBFD symbol and at least one non-SBFD symbol that are within a single slot.

As shown by reference number 910, the network node 110 may optionally transmit at least a portion of the reference signal within at least a portion of the resources by the resource allocation. As described with reference to FIG. 8, the network node 110 may determine whether to drop a portion of the reference signal transmission or drop all of the reference signal transmission (e.g., whether to refrain from transmitting a portion of the reference signal or whether to refrain from transmitting all of the reference signal) in response to whether the number of ports in the SBFD symbol and the non-SBFD symbol are the same and whether the CDM groups associated with the reference signal are each contained with SBFD symbols or non-SBFD symbols (or whether there are any CDM groups that span both SBFD and non-SBFD symbols).

As shown by 915, the UE 120 may optionally monitor one or more symbols for the reference signal. Additionally, and as shown by 920, the UE 110 may optionally refrain from monitoring one or more symbols for the reference signal. For example, as described with reference to FIG. 8, the UE may determine whether to monitor a portion of the resources indicated by the reference signal allocation (e.g., and refrain from monitoring a portion of the resources indicated by the reference signal allocation), all of the resources indicated by the reference signal allocation, or none of the resources indicated by the reference signal allocation, in response to whether the number of ports in the SBFD symbol and the non-SBFD symbol are the same and whether the CDM groups associated with the reference signal are each contained with SBFD symbols or non-SBFD symbols (or whether there are any CDM groups that span both SBFD and non-SBFD symbols).

As shown by 925, the UE 120 may optionally update (or partially update) the CSI-RS. Further, and as shown by 930, the UE 120 may optionally transmit, and the network node 110 may receive, a CSI report. Based on whether the UE 120 updates or partially updates the CSI-RS, the CSI report may correspond to a first channel estimation associated with SBFD communications and/or a second channel estimation associated with non-SBFD communications. For example, the UE may transmit the CSI report that indicates one or more first CSI metrics (e.g., CQI, rank, etc.) that are computed based on the first channel estimation and/or one or more second CSI metrics that are computed based on the second channel estimation.

As indicated above, FIG. 9 is provided as an example. Other examples may differ from what is described with respect to FIG. 9.

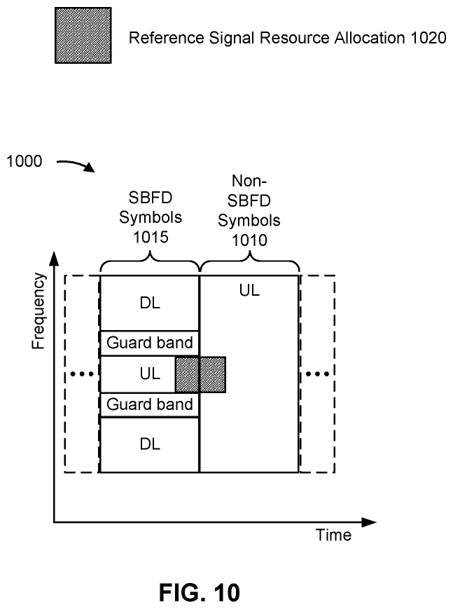

FIG. 10 is a diagram illustrating an example 1000 of a reference signal resource allocation that includes both an SBFD symbol 1015 and a non-SBFD symbol 1010, in accordance with the present disclosure. In the examples 1000, the reference signal resource allocation 1020 may have occasions in both non-SBFD symbols 1010 and SBFD symbols 1015 (e.g., within a single slot). While not illustrated by examples 1000, in some cases there may be a gap symbol that extends between the non-SBFD symbols 1010 and the SBFD symbols 1015.

A network node (e.g., a network node 110) may transmit signaling indicating a reference signal resource allocation 1020 for a reference signal transmission (e.g., an SRS reference signal). In some cases, the resource allocation may include periodic, semi-persistent, or aperiodic resource allocations for the reference signal. In some examples, the resource allocation for the reference signal may indicate a number of ports associated with each symbol. For example, the resource allocation may indicate that the reference signal is mapped to a first number of first ports in the SBFD symbol 1015 and mapped to a second number of second ports in the non-SBFD symbol 1010. Example 1000 may illustrate a case where the reference signal resource allocation 1020 has CDM groups that are associated with TDM2. Here, the reference signal resource allocation 1020 may enable a mapping of eight SRS ports in one SRS resource (e.g., the resource associated with the reference signal resource allocation 1020) to one SBFD symbol 1015 and one non-SBD symbol 1010.

In response to the reference signal resource allocation 1020 including an SBFD symbol 1015 and a non-SBFD symbol 1010, the UE may determine whether to transmit the SRS transmission, transmit a portion of the SRS transmission, or drop the SRS transmission. In one example, the UE may refrain from transmitting the SRS via the resources indicated by the reference signal resource allocation 1020. Here, the network node may additionally refrain from monitoring the resources indicated by the reference signal resource allocation 1020.

In another example, the UE may transmit the SRS transmission in one of the symbols allocated by the reference signal resource allocation 1020 and may refrain from transmitting the SRS transmission in the other one of the symbols allocated by the reference signal resource allocation 1020. Here, the network node may refrain from monitoring one of the symbols (e.g., corresponding to the dropped SRS transmission) and may monitor the other symbol for the SRS transmission. In this example, the network node may perform a partial sounding for the SBFD and non-SBFD channels, as a portion of the ports are sounded (e.g., either in the SBFD symbol 1015 or the non-SBFD symbol 1010).

In another example, the UE may transmit the SRS transmission in both of the symbols allocated by the reference signal resource allocation 1020. Here, the network node may monitor both symbols to attempt to receive the SRS transmission from the UE. In cases where the SRS resource is common for both the SBFD symbol 1015 and the non-SBFD symbol 1010, the network node may perform a complete sounding (e.g., may perform channel estimations for SBFD and non-SBFD channels). Alternatively, if the SRS resource is not common for both the SBFD symbol 1015 and the non-SBFD symbol 1010, the network node may perform a partial sounding for the SBFD and non-SBFD channels, since a subset of the ports are sounded in each symbol type.

As indicated above, FIG. 10 is provided as an example. Other examples may differ from what is described with respect to FIG. 10.

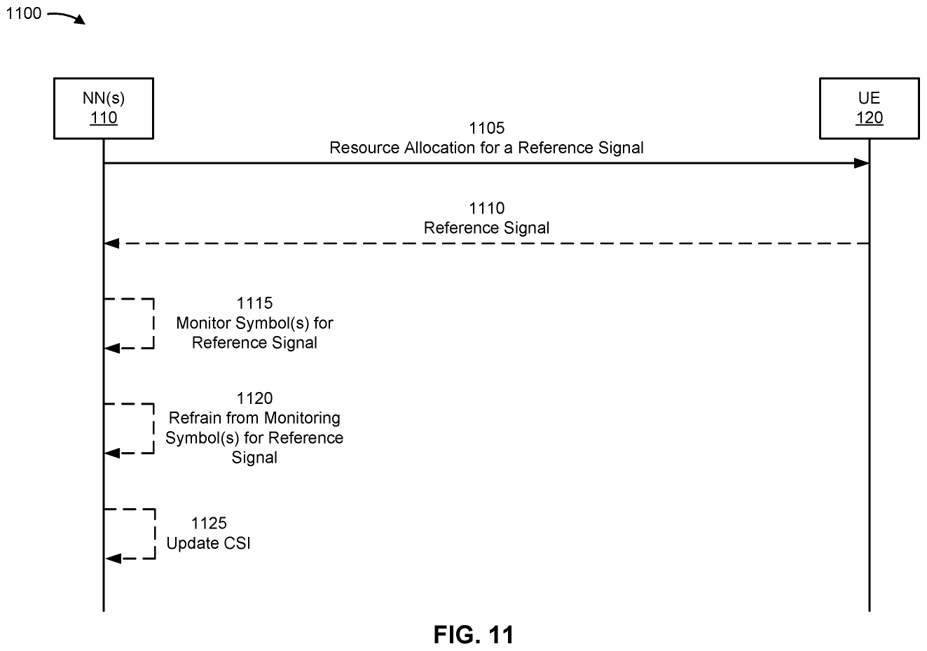

FIG. 11 is a diagram illustrating an example 1100 of communications between a network node 110 and UE 120, in accordance with the present disclosure.

As shown by reference number 1105, the network node 110 may transmit a resource allocation for a reference signal (e.g., an SRS). In some cases, the network node 110 may transmit signaling indicating a resource allocation illustrated by example 1000, as described with reference to FIG. 10. The resource allocation may include at least one SBFD symbol and at least one non-SBFD symbol that are within a single slot.

As shown by reference number 1110, the UE 120 may optionally transmit at least a portion of the reference signal within at least a portion of the resources by the resource allocation. As described with reference to FIG. 10, the UE 120 may determine whether to transmit the entire reference signal transmission, drop a portion of the reference signal transmission, or drop all of the reference signal transmission (e.g., whether to refrain from transmitting a portion of the reference signal or whether to refrain from transmitting all of the reference signal).

As shown by 1115, the network node 110 may optionally monitor one or more symbols for the reference signal. Additionally, and as shown by 1120, the network node 110 may optionally refrain from monitoring one or more symbols for the reference signal. For example, as described with reference to FIG. 10, the network node 110 may determine whether to monitor a portion of the resources indicated by the reference signal allocation (e.g., and refrain from monitoring a portion of the resources indicated by the reference signal allocation), all of the resources indicated by the reference signal allocation, or none of the resources indicated by the reference signal allocation.

As shown by 1125, the network node 110 may optionally update (or partially update) the CSI. For example, the network node 110 may perform a partial or complete sounding in response to receiving the SRS transmission from the UE 120, as described with reference to FIG. 10.

As indicated above, FIG. 11 is provided as an example. Other examples may differ from what is described with respect to FIG. 11.

FIG. 12 is a diagram illustrating an example process 1200 performed, for example, at a UE or an apparatus of a UE, in accordance with the present disclosure. Example process 1200 is an example where the apparatus or the UE (e.g., UE 120) performs operations associated with techniques for communicating based on reference signal allocations.

As shown in FIG. 12, in some aspects, process 1200 may include receiving a resource allocation for a reference signal, wherein the resource allocation for the reference signal comprises an SBFD symbol and a non-SBFD symbol that are within a single slot (block 1210). For example, the UE (e.g., using reception component 1302 and/or communication manager 1306, depicted in FIG. 13) may receive a resource allocation for a reference signal, wherein the resource allocation for the reference signal comprises an SBFD symbol and a non-SBFD symbol that are within a single slot, as described above.

As further shown in FIG. 12, in some aspects, process 1200 may include communicating with a network node in accordance with the resource allocation (block 1220). For example, the UE (e.g., using reception component 1302, transmission component 1304, and/or communication manager 1306, depicted in FIG. 13) may communicate with a network node in accordance with the resource allocation, as described above.

Process 1200 may include additional aspects, such as any single aspect or any combination of aspects described below and/or in connection with one or more other processes described elsewhere herein.

In a first aspect, communicating with the network node comprises refraining from monitoring the SBFD symbol or the non-SBFD symbol for the reference signal in response to the resource allocation for the reference signal comprising the SBFD symbol and the non-SBFD symbol.

In a second aspect, alone or in combination with one or more of the first and second aspects, the resource allocation for the reference signal indicates that the reference signal is mapped to a first number of first ports in the SBFD symbol and is mapped to a second number of second ports in the non-SBFD symbol, and the refraining from monitoring is further in response to the first number of the first ports in the SBFD symbol being the same as the second number of the second ports in the non-SBFD symbol.

In a third aspect, alone or in combination with one or more of the first and second aspects, the resource allocation for the reference signal indicates that the reference signal is mapped to a first number of first ports in the SBFD symbol and is mapped to a second number of second ports in the non-SBFD symbol, and the refraining from monitoring is further in response to the first number of the first ports in the SBFD symbol being different from the second number of the second ports in the non-SBFD symbol.

In a fourth aspect, communicating with the network node comprises monitoring at least one of the SBFD symbol for one or more first CDM groups associated with the reference signal, or the non-SBFD symbol for one or more second CDM groups associated with the reference signal, and transmitting, to the network node, a CSI report corresponding to at least one of a first channel estimation associated with SBFD communications or a second channel estimation associated with non-SBFD communications, wherein the first channel estimation corresponds to receiving the one or more first CDM groups, and the second channel estimation corresponds to receiving the one or more second CDM groups.

In a fifth aspect, alone or in combination with one or more of the first through fourth aspects, the monitoring comprises monitoring the SBFD symbol and the non-SBFD symbol, and transmitting the CSI report comprises transmitting the CSI report corresponding to the first channel estimation associated with the SBFD communications and the second channel estimation associated with the non-SBFD communications.

In a sixth aspect, alone or in combination with one or more of the first through fifth aspects, the monitoring comprises monitoring the SBFD symbol or the non-SBFD symbol, and transmitting the CSI report comprises transmitting the CSI report corresponding to the first channel estimation associated with the SBFD communications or the second channel estimation associated with the non-SBFD communications.

In a seventh aspect, alone or in combination with one or more of the first through sixth aspects, the resource allocation for the reference signal indicates that the reference signal is mapped to a first number of first ports in the SBFD symbol and is mapped to a second number of second ports in the non-SBFD symbol, and transmitting the CSI report corresponding to at least one of the first channel estimation associated with the SBFD communications or the second channel estimation associated with the non-SBFD communications is in response to the first number of the first ports in the SBFD symbol being the same as the second number of the second ports in the non-SBFD symbol.

In an eighth aspect, alone or in combination with one or more of the first through seventh aspects, the resource allocation for the reference signal indicates that the reference signal does not overlap in a time domain with a gap symbol that extends, in the time domain, between an SBFD symbol in the single slot and a non-SBFD symbol in the single slot, and transmitting the CSI report corresponding to at least one of the first channel estimation associated with the SBFD communications or the second channel estimation associated with the non-SBFD communications is in response to the reference signal not overlapping in the time domain with the gap symbol.

In a ninth aspect, alone or in combination with one or more of the first through eighth aspects, the resource allocation for the reference signal indicates that each CDM group associated with the reference signal is contained in either the SBFD symbol or in the non-SBFD symbol, and transmitting the CSI report corresponding to at least one of the first channel estimation associated with the SBFD communications or the second channel estimation associated with the non-SBFD communications is in response to each CDM group associated with the reference signal being contained in either the SBFD symbol or in the non-SBFD symbol.

In a tenth aspect, alone or in combination with one or more of the first through ninth aspects, process 1200 includes receiving, from the network node, configuration information associated with the CSI report that indicates that a time restriction for channel measurements associated with the CSI report is not configured, wherein transmitting the signaling indicating at least one of the first channel estimation associated with the SBFD communications or the second channel estimation associated with the non-SBFD communications is in response to the time restriction for the channel measurements associated with the CSI report not being configured.

In an eleventh aspect, communicating with the network node comprises monitoring a first set of resource elements in the SBFD symbol and a second set of resource elements in the non-SBFD symbol to receive at least a portion of the reference signal, wherein the first set of resource elements and the second set of resource elements span a same set of frequency resources and are configured for downlink communications, refraining from monitoring a third set of resource elements in the SBFD and a fourth set of resource elements in the non-SBFD, wherein the third set of resource elements and the fourth set of resource elements span a same set of frequency resources, and wherein at least a portion of the third set of resource elements are configured for uplink communications, and transmitting, to the network node and in response to receiving at least the portion of the reference signal, a CSI report associated with channel estimations that correspond to the first set of resource elements and the second set of resource elements.

In a twelfth aspect, alone or in combination with one or more of the first through eleventh aspects, process 1200 includes receiving, from the network node, an indication that one or more first transmission parameters associated with a transmission of the reference signal in the SBFD symbol are the same as one or more second transmission parameters associated with a transmission of the reference signal in the non-SBFD symbol, wherein communicating with the network node comprises transmitting, to the network node and in response to the one or more first transmission parameters being the same as the one or more second transmission parameters, a CSI report associated with a first channel estimation associated with SBFD communications and a second channel estimation associated with non-SBFD communications.

In a thirteenth aspect, communicating with the network node comprises refraining from transmitting the reference signal in the SBFD symbol and the non-SBFD symbol in response to the resource allocation for the reference signal comprising the SBFD symbol and the non-SBFD symbol.

In a fourteenth aspect, communicating with the network node comprises transmitting a first portion of the reference signal in a first symbol that comprises either the SBFD symbol or the non-SBFD symbol, and refraining from transmitting a second portion of the reference signal in a second symbol that comprises either the non-SBFD symbol or the SBFD symbol, wherein the first symbol is different from the second symbol.

In a fifteenth aspect, communicating with the network node comprises transmitting the reference signal in the SBFD symbol and the non-SBFD symbol in response to the resource allocation for the reference signal comprising the SBFD symbol and the non-SBFD symbol.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 140 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 4-11. Additionally, or alternatively, the apparatus 1300 may be configured to perform one or more processes described herein, such as process 1200 of FIG. 12. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1304 may be co-located with the reception component 1302 in one or more transceivers.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The reception component 1302 may receive a resource allocation for a reference signal, wherein the resource allocation for the reference signal comprises an SBFD symbol and a non-SBFD symbol that are within a single slot. The reception component 1302 and/or the transmission component 1304 may communicate with a network node in accordance with the resource allocation.

The reception component 1302 may receive, from the network node, configuration information associated with the CSI report that indicates that a time restriction for channel measurements associated with the CSI report is not configured, wherein transmitting the signaling indicating at least one of the first channel estimation associated with the SBFD communications or the second channel estimation associated with the non-SBFD communications is in response to the time restriction for the channel measurements associated with the CSI report not being configured.

The reception component 1302 may receive, from the network node, an indication that one or more first transmission parameters associated with a transmission of the reference signal in the SBFD symbol are the same as one or more second transmission parameters associated with a transmission of the reference signal in the non-SBFD symbol, wherein communicating with the network node comprises the transmission component 13204 transmitting, to the network node and in response to the one or more first transmission parameters being the same as the one or more second transmission parameters, a CSI report associated with a first channel estimation associated with SBFD communications and a second channel estimation associated with non-SBFD communications.

The transmission component 1304 may transmit, to the network node and in response to the one or more first transmission parameters being the same as the one or more second transmission parameters, a CSI report associated with a first channel estimation associated with SBFD communications and a second channel estimation associated with non-SBFD communications.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

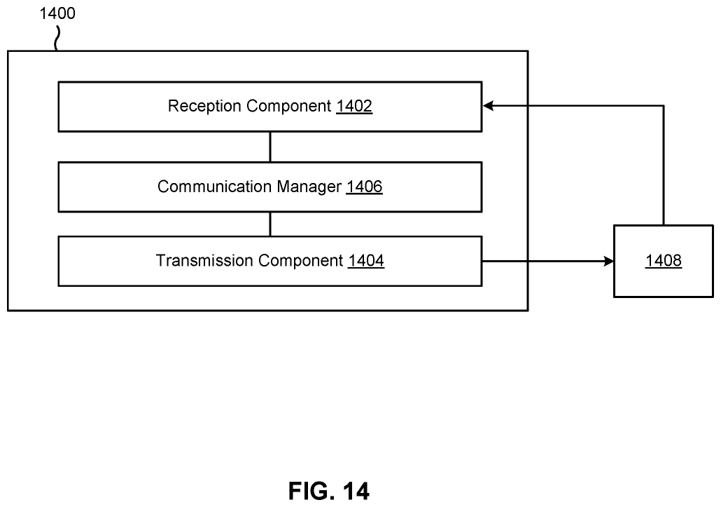

FIG. 14 is a diagram of an example apparatus 1400 for wireless communication, in accordance with the present disclosure. The apparatus 1400 may be a network node, or a network node may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 150 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIGS. 4-11. Additionally, or alternatively, the apparatus 1400 may be configured to perform one or more processes described herein. In some aspects, the apparatus 1400 and/or one or more components shown in FIG. 14 may include one or more components of the network node described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1402 and/or the transmission component 1404 may include or may be included in a network interface. The network interface may be configured to obtain and/or output signals for the apparatus 1400 via one or more communications links, such as a backhaul link, a midhaul link, and/or a fronthaul link.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1404 may be co-located with the reception component 1402 in one or more transceivers.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The transmission component 1404 may transmit, to a UE, a resource allocation for a reference signal, wherein the resource allocation for the reference signal comprises an SBFD symbol and a non-SBFD symbol that are within a single slot. The reception component 1402 and/or the transmission component 1404 may communicate with the UE in accordance with the resource allocation.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a UE, comprising: receiving a resource allocation for a reference signal, wherein the resource allocation for the reference signal comprises an SBFD symbol and a non-SBFD symbol that are within a single slot; and communicating with a network node in accordance with the resource allocation.

Aspect 2: The method of Aspect 1, wherein communicating with the network node comprises: refraining from monitoring the SBFD symbol or the non-SBFD symbol for the reference signal in response to the resource allocation for the reference signal comprising the SBFD symbol and the non-SBFD symbol.

Aspect 3: The method of Aspect 2, wherein: the resource allocation for the reference signal indicates that the reference signal is mapped to a first number of first ports in the SBFD symbol and is mapped to a second number of second ports in the non-SBFD symbol; and the refraining from monitoring is further in response to the first number of the first ports in the SBFD symbol being the same as the second number of the second ports in the non-SBFD symbol.

Aspect 4: The method of Aspect 2, wherein: the resource allocation for the reference signal indicates that the reference signal is mapped to a first number of first ports in the SBFD symbol and is mapped to a second number of second ports in the non-SBFD symbol; and the refraining from monitoring is further in response to the first number of the first ports in the SBFD symbol being different from the second number of the second ports in the non-SBFD symbol.

Aspect 5: The method of Aspect 1, wherein communicating with the network node comprises: monitoring at least one of: the SBFD symbol for one or more first CDM groups associated with the reference signal, or the non-SBFD symbol for one or more second CDM groups associated with the reference signal; and transmitting, to the network node, a CSI report corresponding to at least one of a first channel estimation associated with SBFD communications or a second channel estimation associated with non-SBFD communications, wherein: the first channel estimation corresponds to receiving the one or more first CDM groups, and the second channel estimation corresponds to receiving the one or more second CDM groups.

Aspect 6: The method of Aspect 5, wherein: the monitoring comprises monitoring the SBFD symbol and the non-SBFD symbol; and transmitting the CSI report comprises transmitting the CSI report corresponding to the first channel estimation associated with the SBFD communications and the second channel estimation associated with the non-SBFD communications.

Aspect 7: The method of Aspect 5, wherein: the monitoring comprises monitoring the SBFD symbol or the non-SBFD symbol; and transmitting the CSI report comprises transmitting the CSI report corresponding to the first channel estimation associated with the SBFD communications or the second channel estimation associated with the non-SBFD communications.

Aspect 8: The method of Aspect 5, wherein: the resource allocation for the reference signal indicates that the reference signal is mapped to a first number of first ports in the SBFD symbol and is mapped to a second number of second ports in the non-SBFD symbol; and transmitting the CSI report corresponding to at least one of the first channel estimation associated with the SBFD communications or the second channel estimation associated with the non-SBFD communications is in response to the first number of the first ports in the SBFD symbol being the same as the second number of the second ports in the non-SBFD symbol.

Aspect 9: The method of Aspect 5, wherein: the resource allocation for the reference signal indicates that the reference signal does not overlap in a time domain with a gap symbol that extends, in the time domain, between an SBFD symbol in the single slot and a non-SBFD symbol in the single slot; and transmitting the CSI report corresponding to at least one of the first channel estimation associated with the SBFD communications or the second channel estimation associated with the non-SBFD communications is in response to the reference signal not overlapping in the time domain with the gap symbol.

Aspect 10: The method of Aspect 5, wherein: the resource allocation for the reference signal indicates that each CDM group associated with the reference signal is contained in either the SBFD symbol or in the non-SBFD symbol; and transmitting the CSI report corresponding to at least one of the first channel estimation associated with the SBFD communications or the second channel estimation associated with the non-SBFD communications is in response to each CDM group associated with the reference signal being contained in either the SBFD symbol or in the non-SBFD symbol.

Aspect 11: The method of Aspect 5, further comprising: receiving, from the network node, configuration information associated with the CSI report that indicates that a time restriction for channel measurements associated with the CSI report is not configured, wherein transmitting the signaling indicating at least one of the first channel estimation associated with the SBFD communications or the second channel estimation associated with the non-SBFD communications is in response to the time restriction for the channel measurements associated with the CSI report not being configured.

Aspect 12: The method of Aspect 1, wherein communicating with the network node comprises: monitoring a first set of resource elements in the SBFD symbol and a second set of resource elements in the non-SBFD symbol to receive at least a portion of the reference signal, wherein the first set of resource elements and the second set of resource elements span a same set of frequency resources and are configured for downlink communications; refraining from monitoring a third set of resource elements in the SBFD and a fourth set of resource elements in the non-SBFD, wherein the third set of resource elements and the fourth set of resource elements span a same set of frequency resources, and wherein at least a portion of the third set of resource elements are configured for uplink communications; and transmitting, to the network node and in response to receiving at least the portion of the reference signal, a CSI report associated with channel estimations that correspond to the first set of resource elements and the second set of resource elements.

Aspect 13: The method of Aspect 1, further comprising: receiving, from the network node, an indication that one or more first transmission parameters associated with a transmission of the reference signal in the SBFD symbol are the same as one or more second transmission parameters associated with a transmission of the reference signal in the non-SBFD symbol, wherein communicating with the network node comprises: transmitting, to the network node and in response to the one or more first transmission parameters being the same as the one or more second transmission parameters, a CSI report associated with a first channel estimation associated with SBFD communications and a second channel estimation associated with non-SBFD communications.

Aspect 14: The method of Aspect 1, wherein communicating with the network node comprises: refraining from transmitting the reference signal in the SBFD symbol and the non-SBFD symbol in response to the resource allocation for the reference signal comprising the SBFD symbol and the non-SBFD symbol.

Aspect 15: The method of Aspect 1, wherein communicating with the network node comprises: transmitting a first portion of the reference signal in a first symbol that comprises either the SBFD symbol or the non-SBFD symbol; and refraining from transmitting a second portion of the reference signal in a second symbol that comprises either the non-SBFD symbol or the SBFD symbol, wherein the first symbol is different from the second symbol.

Aspect 16: The method of Aspect 1, wherein communicating with the network node comprises: transmitting the reference signal in the SBFD symbol and the non-SBFD symbol in response to the resource allocation for the reference signal comprising the SBFD symbol and the non-SBFD symbol.

Aspect 17: A method of wireless communication performed by a network node, comprising: transmitting, to a UE, a resource allocation for a reference signal, wherein the resource allocation for the reference signal comprises an SBFD symbol and a non-SBFD symbol that are within a single slot; and communicating with the UE in accordance with the resource allocation.

Aspect 18: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-17.

Aspect 19: An apparatus for wireless communication at a device, the apparatus comprising one or more memories and one or more processors coupled to the one or more memories, the one or more processors configured to cause the device to perform the method of one or more of Aspects 1-17.

Aspect 20: An apparatus for wireless communication, the apparatus comprising at least one means for performing the method of one or more of Aspects 1-17.

Aspect 21: A non-transitory computer-readable medium storing code for wireless communication, the code comprising instructions executable by one or more processors to perform the method of one or more of Aspects 1-17.

Aspect 22: A non-transitory computer-readable medium storing a set of instructions for wireless communication, the set of instructions comprising one or more instructions that, when executed by one or more processors of a device, cause the device to perform the method of one or more of Aspects 1-17.

Aspect 23: A device for wireless communication, the device comprising a processing system that includes one or more processors and one or more memories coupled with the one or more processors, the processing system configured to cause the device to perform the method of one or more of Aspects 1-17.

Aspect 24: An apparatus for wireless communication at a device, the apparatus comprising one or more memories and one or more processors coupled to the one or more memories, the one or more processors individually or collectively configured to cause the device to perform the method of one or more of Aspects 1-17.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. An apparatus for wireless communication at a user equipment (UE), comprising:
one or more memories; and
one or more processors, coupled to the one or more memories, configured to cause the UE to:
receive a resource allocation for a reference signal,
wherein the resource allocation for the reference signal comprises a sub-band full duplex (SBFD) symbol and a non-SBFD symbol that are within a single slot; and
communicate with a network node in accordance with the resource allocation.

2. The apparatus of claim 1, wherein the one or more processors, to cause the UE to communicate with the network node, are configured to cause the UE to:
refrain from monitoring the SBFD symbol or the non-SBFD symbol for the reference signal in response to the resource allocation for the reference signal comprising the SBFD symbol and the non-SBFD symbol.

3. The apparatus of claim 2, wherein:
the resource allocation for the reference signal indicates that the reference signal is mapped to a first number of first ports in the SBFD symbol and is mapped to a second number of second ports in the non-SBFD symbol; and
the refraining from monitoring is further in response to the first number of the first ports in the SBFD symbol being the same as the second number of the second ports in the non-SBFD symbol.

4. The apparatus of claim 2, wherein:
the resource allocation for the reference signal indicates that the reference signal is mapped to a first number of first ports in the SBFD symbol and is mapped to a second number of second ports in the non-SBFD symbol; and
the refraining from monitoring is further in response to the first number of the first ports in the SBFD symbol being different from the second number of the second ports in the non-SBFD symbol.

5. The apparatus of claim 1, wherein the one or more processors, to cause the UE to communicate with the network node, are configured to cause the UE to:
monitor at least one of:
the SBFD symbol for one or more first code-division multiplexing groups associated with the reference signal, or
the non-SBFD symbol for one or more second code-division multiplexing groups associated with the reference signal; and
transmit, to the network node, a channel state information report corresponding to at least one of a first channel estimation associated with SBFD communications or a second channel estimation associated with non-SBFD communications, wherein:
the first channel estimation corresponds to receiving the one or more first code-division multiplexing groups, and
the second channel estimation corresponds to receiving the one or more second code-division multiplexing groups.

6. The apparatus of claim 5, wherein:
the monitoring comprises monitoring the SBFD symbol and the non-SBFD symbol; and
transmitting the channel state information report comprises transmitting the channel state information report corresponding to the first channel estimation associated with the SBFD communications and the second channel estimation associated with the non-SBFD communications.

7. The apparatus of claim 5, wherein:
the monitoring comprises monitoring the SBFD symbol or the non-SBFD symbol; and
transmitting the channel state information report comprises transmitting the channel state information report corresponding to the first channel estimation associated with the SBFD communications or the second channel estimation associated with the non-SBFD communications.

8. The apparatus of claim 5, wherein:
the resource allocation for the reference signal indicates that the reference signal is mapped to a first number of first ports in the SBFD symbol and is mapped to a second number of second ports in the non-SBFD symbol; and
transmitting the channel state information report corresponding to at least one of the first channel estimation associated with the SBFD communications or the second channel estimation associated with the non-SBFD communications is in response to the first number of the first ports in the SBFD symbol being the same as the second number of the second ports in the non-SBFD symbol.

9. The apparatus of claim 5, wherein:
the resource allocation for the reference signal indicates that the reference signal does not overlap in a time domain with a gap symbol that extends, in the time domain, between an SBFD symbol in the single slot and a non-SBFD symbol in the single slot; and
transmitting the channel state information report corresponding to at least one of the first channel estimation associated with the SBFD communications or the second channel estimation associated with the non-SBFD communications is in response to the reference signal not overlapping in the time domain with the gap symbol.

10. The apparatus of claim 5, wherein:
the resource allocation for the reference signal indicates that each code-division multiplexing group associated with the reference signal is contained in either the SBFD symbol or in the non-SBFD symbol; and
transmitting the channel state information report corresponding to at least one of the first channel estimation associated with the SBFD communications or the second channel estimation associated with the non-SBFD communications is in response to each code-division multiplexing group associated with the reference signal being contained in either the SBFD symbol or in the non-SBFD symbol.

11. The apparatus of claim 5, wherein the one or more processors are further configured to cause the UE to:
receive, from the network node, configuration information associated with the channel state information report that indicates that a time restriction for channel measurements associated with the channel state information report is not configured, wherein transmitting the signaling indicating at least one of the first channel estimation associated with the SBFD communications or the second channel estimation associated with the non-SBFD communications is in response to the time restriction for the channel measurements associated with the channel state information report not being configured.

12. The apparatus of claim 1, wherein the one or more processors are further configured to cause the UE to:
monitor a first set of resource elements in the SBFD symbol and a second set of resource elements in the non-SBFD symbol to receive at least a portion of the reference signal,
wherein the first set of resource elements and the second set of resource elements span a same set of frequency resources and are configured for downlink communications;
refrain from monitoring a third set of resource elements in the SBFD and a fourth set of resource elements in the non-SBFD,
wherein the third set of resource elements and the fourth set of resource elements span a same set of frequency resources, and
wherein at least a portion of the third set of resource elements are configured for uplink communications; and
transmit, to the network node and in response to receiving at least the portion of the reference signal, a channel state information report associated with channel estimations that correspond to the first set of resource elements and the second set of resource elements.

13. The apparatus of claim 1, wherein the one or more processors are further configured to cause the UE to:
receive, from the network node, an indication that one or more first transmission parameters associated with a transmission of the reference signal in the SBFD symbol are the same as one or more second transmission parameters associated with a transmission of the reference signal in the non-SBFD symbol, wherein communicating with the network node comprises:
transmit, to the network node and in response to the one or more first transmission parameters being the same as the one or more second transmission parameters, a channel state information report associated with a first channel estimation associated with SBFD communications and a second channel estimation associated with non-SBFD communications.

14. The apparatus of claim 1, wherein the one or more processors, to cause the UE to communicate with the network node, are configured to cause the UE to:
refrain from transmitting the reference signal in the SBFD symbol and the non-SBFD symbol in response to the resource allocation for the reference signal comprising the SBFD symbol and the non-SBFD symbol.

15. The apparatus of claim 1, wherein the one or more processors, to cause the UE to communicate with the network node, are configured to cause the UE to:
transmit a first portion of the reference signal in a first symbol that comprises either the SBFD symbol or the non-SBFD symbol; and
refrain from transmitting a second portion of the reference signal in a second symbol that comprises either the non-SBFD symbol or the SBFD symbol,
wherein the first symbol is different from the second symbol.

16. The apparatus of claim 1, wherein the one or more processors, to cause the UE to communicate with the network node, are configured to cause the UE to:
transmit the reference signal in the SBFD symbol and the non-SBFD symbol in response to the resource allocation for the reference signal comprising the SBFD symbol and the non-SBFD symbol.

17. A method of wireless communication performed by a user equipment (UE), comprising:
receiving a resource allocation for a reference signal,
wherein the resource allocation for the reference signal comprises a sub-band full duplex (SBFD) symbol and a non-SBFD symbol that are within a single slot; and
communicating with a network node in accordance with the resource allocation.

18. The method of claim 17, wherein communicating with the network node comprises:
refraining from monitoring the SBFD symbol or the non-SBFD symbol for the reference signal in response to the resource allocation for the reference signal comprising the SBFD symbol and the non-SBFD symbol.

19. The method of claim 18, wherein:
the resource allocation for the reference signal indicates that the reference signal is mapped to a first number of first ports in the SBFD symbol and is mapped to a second number of second ports in the non-SBFD symbol; and
the refraining from monitoring is further in response to the first number of the first ports in the SBFD symbol being the same as the second number of the second ports in the non-SBFD symbol.

20. The method of claim 18, wherein:
the resource allocation for the reference signal indicates that the reference signal is mapped to a first number of first ports in the SBFD symbol and is mapped to a second number of second ports in the non-SBFD symbol; and
the refraining from monitoring is further in response to the first number of the first ports in the SBFD symbol being different from the second number of the second ports in the non-SBFD symbol.

21. The method of claim 17, wherein communicating with the network node comprises:
monitoring at least one of:
the SBFD symbol for one or more first code-division multiplexing groups associated with the reference signal, or
the non-SBFD symbol for one or more second code-division multiplexing groups associated with the reference signal; and
transmitting, to the network node, a channel state information report corresponding to at least one of a first channel estimation associated with SBFD communications or a second channel estimation associated with non-SBFD communications, wherein:
the first channel estimation corresponds to receiving the one or more first code-division multiplexing groups, and
the second channel estimation corresponds to receiving the one or more second code-division multiplexing groups.

22. The method of claim 21, wherein:
the monitoring comprises monitoring the SBFD symbol and the non-SBFD symbol; and
transmitting the channel state information report comprises transmitting the channel state information report corresponding to the first channel estimation associated with the SBFD communications and the second channel estimation associated with the non-SBFD communications.

23. The method of claim 21, wherein:
the monitoring comprises monitoring the SBFD symbol or the non-SBFD symbol; and
transmitting the channel state information report comprises transmitting the channel state information report corresponding to the first channel estimation associated with the SBFD communications or the second channel estimation associated with the non-SBFD communications.

24. The method of claim 21, wherein:
the resource allocation for the reference signal indicates that the reference signal is mapped to a first number of first ports in the SBFD symbol and is mapped to a second number of second ports in the non-SBFD symbol; and
transmitting the channel state information report corresponding to at least one of the first channel estimation associated with the SBFD communications or the second channel estimation associated with the non-SBFD communications is in response to the first number of the first ports in the SBFD symbol being the same as the second number of the second ports in the non-SBFD symbol.

25. The method of claim 21, wherein:
the resource allocation for the reference signal indicates that the reference signal does not overlap in a time domain with a gap symbol that extends, in the time domain, between an SBFD symbol in the single slot and a non-SBFD symbol in the single slot; and
transmitting the channel state information report corresponding to at least one of the first channel estimation associated with the SBFD communications or the second channel estimation associated with the non-SBFD communications is in response to the reference signal not overlapping in the time domain with the gap symbol.

26. The method of claim 21, wherein:
the resource allocation for the reference signal indicates that each code-division multiplexing group associated with the reference signal is contained in either the SBFD symbol or in the non-SBFD symbol; and
transmitting the channel state information report corresponding to at least one of the first channel estimation associated with the SBFD communications or the second channel estimation associated with the non-SBFD communications is in response to each code-division multiplexing group associated with the reference signal being contained in either the SBFD symbol or in the non-SBFD symbol.

27. The method of claim 21, further comprising:
receiving, from the network node, configuration information associated with the channel state information report that indicates that a time restriction for channel measurements associated with the channel state information report is not configured, wherein transmitting the signaling indicating at least one of the first channel estimation associated with the SBFD communications or the second channel estimation associated with the non-SBFD communications is in response to the time restriction for the channel measurements associated with the channel state information report not being configured.

28. The method of claim 17, wherein communicating with the network node comprises:
monitoring a first set of resource elements in the SBFD symbol and a second set of resource elements in the non-SBFD symbol to receive at least a portion of the reference signal,
wherein the first set of resource elements and the second set of resource elements span a same set of frequency resources and are configured for downlink communications;
refraining from monitoring a third set of resource elements in the SBFD and a fourth set of resource elements in the non-SBFD,
wherein the third set of resource elements and the fourth set of resource elements span a same set of frequency resources, and
wherein at least a portion of the third set of resource elements are configured for uplink communications; and
transmitting, to the network node and in response to receiving at least the portion of the reference signal, a channel state information report associated with channel estimations that correspond to the first set of resource elements and the second set of resource elements.

29. A non-transitory computer-readable medium storing a set of instructions for wireless communication, the set of instructions comprising:
one or more instructions that, when executed by one or more processors of a user equipment (UE), cause the UE to:
receive a resource allocation for a reference signal,
wherein the resource allocation for the reference signal comprises a sub-band full duplex (SBFD) symbol and a non-SBFD symbol that are within a single slot; and
communicate with a network node in accordance with the resource allocation.

30. An apparatus for wireless communication, comprising:
means for receiving a resource allocation for a reference signal,
wherein the resource allocation for the reference signal comprises a sub-band full duplex (SBFD) symbol and a non-SBFD symbol that are within a single slot; and
means for communicating with a network node in accordance with the resource allocation.
